(19) United States
(12) Patent Application Publication
(10) Pub. No.: US 2007/0131755 A1
(43) Pub. Date: Jun. 14, 2007

(54) Left/right side direction switching mechanism of traveling data recorder for vehicle

(76) Inventor: Ching-Shan Chang, Xinzhuang City (TW)

Correspondence Address: J.C. Patents, Inc., Suite 250, 4 Venture, Irvine, CA, 92618, US

(21) Appl. No.: 11/355,623

(22) Filed: Feb. 15, 2006

(30) Foreign Application Priority Data
Dec. 12, 2005 (TW) 94143835

(51) Int. Cl. G06F 17/00; G07B 15/02

(52) U.S. Cl. 235/375; 235/384

(57) ABSTRACT

A traveling data recorder for vehicle is provided. The vehicle traveling data recorder includes an information capturing apparatus having a plurality of data collection modules, a sensor, a display, a storage apparatus and a controller. The data collection modules are disposed on the outer side body of the vehicle for collecting the information of a space surrounding the vehicle. The sensor is adopted for detecting the on/off status of the vehicle's turn signals. The control unit is coupled to the sensor, and when a turn signal is turned on, the controller turns on at least one of the data collection modules corresponding to the turn signal to collect the information of a space surrounding the vehicle. The information is displayed on the display and stored in the storage apparatus.

### CROSS-REFERENCE TO RELATED APPLICATION

This application claims the priority benefit of Taiwan application serial no. 94143835, filed on Dec. 12, 2005. All disclosure of the Taiwan application is incorporated herein by reference.

### BACKGROUND OF THE INVENTION

1. Field of the Invention

The present invention relates to a traveling data recorder. More particularly, the present invention relates to a traveling data recorder that utilizes left/right side direction switching mechanism to capture information regarding the space surrounding the vehicle and thereby improve the safety of the driver.

2. Description of Related Art

Nowadays, people give more and more attention to their own safety, and thus, when buying a vehicle, the question as to whether the vehicle can provide adequate safety and protection is considered besides the performance and comfort of the vehicle. Accordingly, vehicle manufacturers and vehicle parts manufacturers are trying their best to improve the safety level of the vehicles by, for example, increasing the rigidity of the vehicle structure, installing air bags and or installing an ABS system in the vehicle.

Moreover, the camera for viewing the surroundings of the vehicle, so as to reduce the driver's visual dead angles and to reduce the chance of accidents accordingly, has become an essential equipment of some vehicles. However, the conventional technology for providing environmental information to the driver is fixed and cannot be changed according to the requirements of the driver.

### SUMMARY OF THE INVENTION

Accordingly, the present invention is directed to a traveling data recorder for vehicles capable of providing the information regarding the space surrounding the vehicle and the driving conditions to the driver according to the requirements of the driver.

According to another aspect of the present invention, a method of recording travel information is provided, wherein the traveling data recorder is adopted for monitoring and storing the real time information regarding the space surrounding the vehicle, so that in case of any abnormal event, for example, an accident, it can be duly recorded as evidence.

The present invention provides a traveling data recorder for vehicle. The traveling data recorder comprises of a data collection apparatus having a plurality of data collection modules, a sensor, a display, a storage apparatus and a controller. Wherein, the data collection modules are disposed on the body outside of the vehicle for collecting the information regarding the space surrounding the vehicle. The sensor is adopted for detecting and transmitting the on/off status of the vehicle's turn signals to the controller when a turn signal is turned on. Accordingly, the controller turns at least one of the data collection modules located at a predetermined location according to the turn signal to collect information, and to display the information on the display, and to store the information in the storage apparatus.

According to an exemplary embodiment of the present invention, the traveling data recorder for a vehicle includes a read-only memory, a user control interface and a power supply unit. Wherein, the read-only memory is coupled to the controller for storing the Basic Input/Output System (BIOS). The user control interface is coupled to the controller to receive control instructions input by the user and sending the control instructions to the controller. The power supply unit is coupled to the in-car power supply to provide power required by the operation of the multidirectional switching mechanism of the vehicle traveling data recorder.

According to another aspect of the present invention, a method of recording information regarding the space surrounding the vehicle is provided. First, whether or not a turn signal is turned on is determined as follows, wherein when a turn signal is turned on, the information regarding the space surrounding the outside of the vehicle in a predetermined direction is collected according to the turn signal, and the collected information is displayed on the display for the driver to view, and the collected information is stored.

As described above, the information regarded the space surrounding the vehicle is captured in response to the on/off status of turn signals using the left/right side direction switching mechanism of the traveling data recorder and displayed on the display and then recorded so that non-visibility of objects at the dead angles can be avoided.

In order to make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram illustrating a traveling data recorder according to an exemplary embodiment of the present invention.

FIG. 2 is a diagram illustrating the allocation of a data collection module according to an exemplary embodiment of the present invention.

FIG. 3 is a flowchart illustrating a method of recording information regarding the space surrounding the outside of the vehicle according to an embodiment of the present invention.

### DESCRIPTION OF EMBODIMENTS

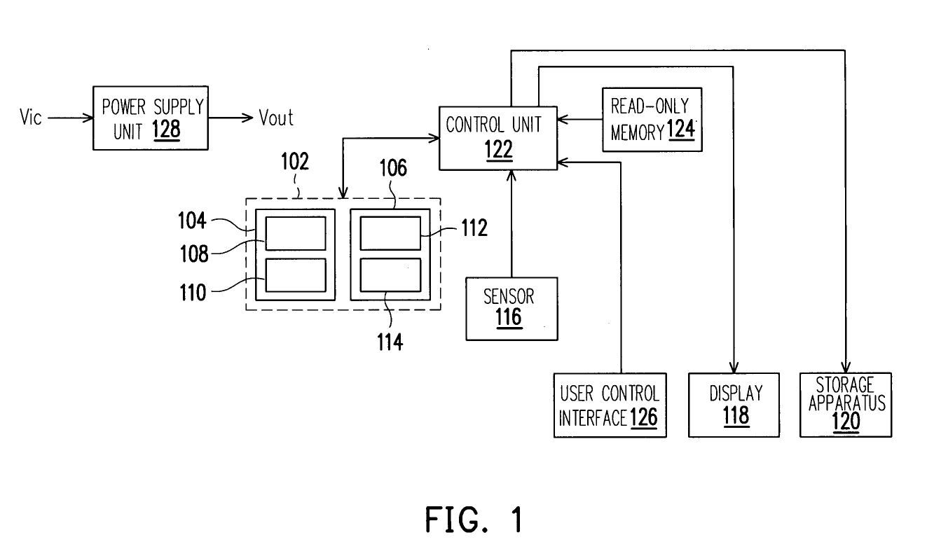

FIG. 1 is a block diagram illustrating a traveling data recorder for a vehicle according to an exemplary embodiment of the present invention. Referring to FIG. 1, the traveling data recorder for the vehicle in the present invention includes a data collection apparatus 102, a sensor 116, a display 118, a storage apparatus 120 and a controller 122. Wherein, the controller 122 is coupled to the sensor 116, the display 118, the storage apparatus 120 and the data collection apparatus 102.

In the present invention, the data collection apparatus 102 is disposed on the outer side body of the vehicle for collecting the information regarding the space surrounding the outside of the vehicle. In addition, the sensor 116 is used for detecting the on/off status of the turn signals of the vehicle. When the driver turns on a turn signal of the vehicle, the controller 122 detects this activated status through the sensor 116. In doing so, the controller 122 displays the information collected by the data collection apparatus 102 on the display 118, and the information is stored into the storage apparatus 120.

Moreover, in an exemplary embodiment, the traveling data recorder in the present invention may further include a read-only memory 124, a user control interface 126 and a power supply unit 128. Wherein, the read-only memory 124 is adopted for storing the Basic Input/Output System (BIOS), and the user control interface 126 is adopted for transferring the control commands input by the user to the controller 122. For example, the user may choose whether or not to turn on the traveling data recorder or control the operations of the data collection apparatus 102 and the display 118 by operating the user control interface 126. In addition, the power supply unit 128 can be coupled to the in-car power supply Vic to provide power Vout to the traveling data recorder.

In an embodiment of the present invention, the data collection apparatus 102 has a plurality of data collection modules. For example, in the present embodiment, the data collection apparatus 102 may include a left side data collection module 104 disposed on the vehicle's left side-rear-view mirror, and a right side data collection module 106 disposed on the vehicle's right side-rear-view mirror correspondingly. Moreover, each data collection module includes an image capturing device (for example, 108 and 112) and a receiver (for example, 110 and 114). Wherein, the image capturing devices 108 and 112 may be a Charge Coupled Device Camera (CCD Camera) or a Complementary Metal-Oxide Semiconductor (CMOS) lens. The image capturing devices 108 and 102 are used for capturing images and the receivers 110 and 114 are used for receiving sounds of the space surrounding the outside of the vehicle. Furthermore, the data collection apparatus 102 is further connected with other data collection modules besides the left side data collection module 104 and the right side data collection module 106.

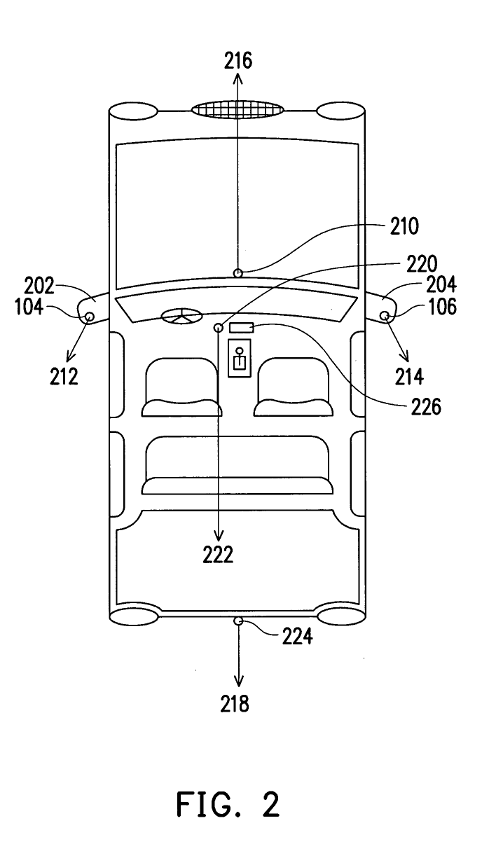

FIG. 2 is a diagram illustrating the disposition location of a data collection module according to an exemplary embodiment of the present invention. Referring to FIG. 2, a plurality of data collection modules may be disposed on the outer side of the body of a vehicle. For example, the left side data collection module 104 in FIG. 1 may be disposed on the left side-rear-view mirror 202 and may be adopted for collecting information regarding the space surrounding the vehicle along a direction 212. In addition, the right side data collection module 106 may be disposed on the right side-rear-view mirror 204 and may be adopted for collecting information regarding the space surrounding the vehicle along a direction 214.

Moreover, in an exemplary embodiment, other data collection modules may also be disposed on the outer side of the body of the vehicle. For example, a data collection module 210 may be disposed on the engine bonnet and may be adopted for collecting information regarding the space surrounding the vehicle along a direction 216. Or a data collection module 224 may be disposed on the lid of the trunk and may be adopted for collecting information regarding the space surrounding the vehicle along a direction 218. Moreover, if the backseat is required to be monitored (for example, a child is sitting in the backseat), a data collection module 220 may be disposed around the driver's seat and may be adopted for collecting the information of the space surrounding the back seat in the vehicle along a direction 222. Thus, the user may monitor the information inside and outside of the vehicle in different directions through a monitor 226.

The foregoing allocations of the data collection modules and the information collection coverage thereof are not limited to those described with reference to FIG. 2; the allocation of the data collection modules may be set according to the specific requirement. Moreover, the image displayed by the monitor and the sound output by the speaker at any time are not limited to the image or sound captured by a particular data collection module; multiple images or sounds captured by all of the data collection modules may be simultaneously displayed on the display and or sounds captured by all of the data collection modules may be output simultaneously.

Referring to FIG. 1 again, as described above, the sensor 116 is adopted for detecting the on/off status of the turn signals of the vehicle. Assuming that the driver turns on the left turn signal, then the sensor 116 provides a detection signal to the controller 122 and controls the left side data collection module 104 to capture the images of any objects and the sounds of the space surrounding the left side of the vehicle, and then the controller 122 transmits the images and sounds captured by the left side data collection module 104 to the display 118 and speaker respectively so that the image may be displayed and sound may be output on real time basis. Meanwhile, the controller 122 may store the information captured by the left side data collection module 104 into the storage apparatus 120.

Correspondingly, when the sensor 116 detects that the right turn signal of the vehicle is turned on, a detection signal is then sent to the controller 122, and controls the right side data collection module 106 to capture the image and sound of the space surrounding the right side of the vehicle and transmits the image and sound captured by the right side data collection module 106 to the display 118 and the speaker so that the image and sound may be displayed and output on a real time basis. Similarly, the controller 122 may also store the image and sound captured by the right side data collection module 106 into the storage apparatus 120. The storage apparatus 120 may comprise a hard disk apparatus.

According to an aspect of the present invention, the data collection modules may be selectively operated to capture the images and sounds without turning on the left/right side direction switching mechanism.

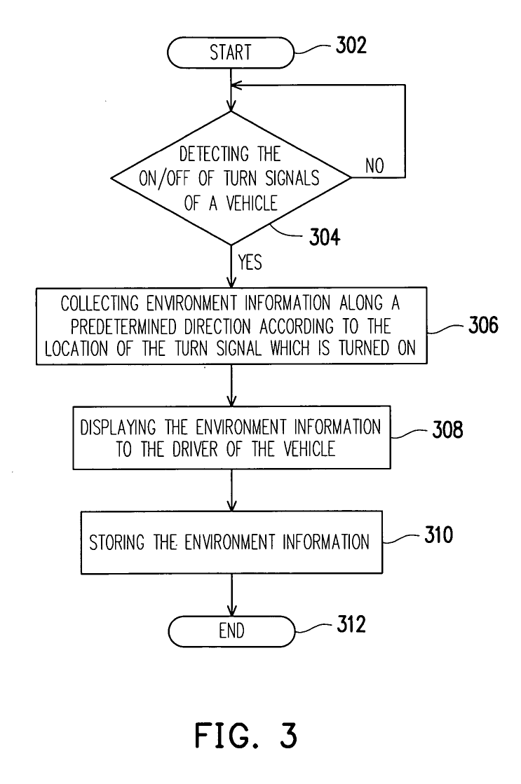

FIG. 3 is a flowchart illustrating a method of recording information regarding the space surrounding the vehicle according to an embodiment of the present invention. First, the driver starts the engine of the vehicle (step 302). Next, whether the turn signal of the vehicle is turned on is determined (step 304), wherein when the turn signal of the vehicle is not turned on, the procedure remains in step 304 until the turn signal is turned on. When the turn signal of the vehicle is turned on, the information is captured by the corresponding data collection module according to the turn signal (step 306). For example, when the left side turn signal is turned on, the images and sounds of the space surrounding the left side of the vehicle are captured by the left side data collection module, and when the right side turn signal is turned on, the images and sounds of the space surrounding the right side of the vehicle are captured.

Thereafter, the captured information is output (step 308), so that the driver may monitor the space surrounding the vehicle on real time basis. Moreover, in an exemplary embodiment of the present invention, the information may be stored (step 310), and the procedure ends at step 312.

In summary, according to the present invention, when the user turns on the turn signal, the traveling data recorder for a vehicle is turned on to capture information regarding the space surrounding the vehicle and display the information on the display and then store the information in the storage apparatus so that the objects at the dead angles may be viewed by the driver, and thereby improve the safety of the driver, the passengers, and the pedestrians around the vehicle. Furthermore, in the event of an accident, the cause of the accident may be recorded which may be used as evidence. Thus, the present invention can provide adequate protection to drivers and passengers.

In addition, the traveling data recorder of the present invention may also be selectively turned without turning on the turn signal to view the space surrounding the vehicle before switching the lanes or turning. Accordingly, driving safety can be protected.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A traveling data recorder for a vehicle, comprising:
a data collection apparatus, having a plurality of data collection modules disposed on an outer side body of a vehicle, used for collecting information regarding the space surrounding the vehicle;
a sensor, adopted for detecting the on/off status of a turn signal of the vehicle;
a display, adopted for displaying the information collected by at least one of the data collection modules;
a storage apparatus, adopted for storing the information collected by at least one of the data collection modules; and
a control unit, coupled to the sensor, wherein when a turn signal of the vehicle is turned on, at least one of the data collection modules corresponding to the turn signal is activated to capture information and then display the collected information on the display and store the collected information into the storage apparatus.

2. The traveling data recorder as claimed in claim 1, wherein each of the data collection modules includes:
an image capturing device, adopted for capturing images of the space surrounding a vehicle; and
a receiver, adopted for capturing sounds of the space surrounding the vehicle.

3. The traveling data recorder as claimed in claim 2, wherein the image capturing device includes a Charge Coupled Device Camera (CCD).

4. The traveling data recorder as claimed in claim 2, wherein the image capturing device includes a Complementary Metal-Oxide Semiconductor (CMOS) lens.

5. The traveling data recorder as claimed in claim 1, wherein the storage apparatus includes a hard disk apparatus.

6. The traveling data recorder as claimed in claim 1, further comprising:
a read-only memory, coupled to the controller, adopted for storing Basic Input/Output System (BIOS);
a user control interface, coupled to the controller, adopted for receiving control instructions input by a user and sending the control instructions to the controller; and
a power supply unit, coupled to a in-car power supply, adopted for providing power for operating the traveling data recorder.

7. The traveling data recorder as claimed in claim 1, wherein the data collection modules comprise:
a left side data collection module, disposed on a left side-rear-view mirror of the vehicle for collecting information regarding the space surrounding a left side of the vehicle; and
a right side data collection module, disposed on the right side-rear-view mirror of the vehicle for collecting information of the space surrounding a right side of the vehicle.

8. A method of recording information of the space surrounding a vehicle, comprising:
detecting an on/off status of a turn signal of the vehicle;
turning on a traveling data recorder in response to a detection of an activated status of the turn signal of the vehicle to capture information of the space surrounding the vehicle along a predetermined direction;
displaying the captured information on the display; and
storing the captured information into a storage apparatus.

9. The method as claimed in claim 8, wherein the information includes the images and the sounds.

10. The method as claimed in claim 8, wherein when a left turn signal of the vehicle is turned on, a left side data collection module of the vehicle is turned on.

11. The trip recording method as claimed in claim 8, wherein when a right turn signal of the vehicle is turned on, a right side data collection module of the vehicle is turned on.
